(19) United States
(12) Patent Application Publication
(10) Pub. No.: US 2007/0257456 A1
(43) Pub. Date: Nov. 8, 2007

(54) Wheelbarrow stand pre-assembly

(76) Inventor: William Kurt Feick, New Canaan, CT (US)

Correspondence Address: ST. ONGE STEWARD JOHNSTON & REENS, LLC, 986 BEDFORD STREET, STAMFORD, CT, 06905-5619, US

(21) Appl. No.: 11/429,600

(22) Filed: May 5, 2006

(51) Int. Cl. B62B 1/18

(52) U.S. Cl. 280/47.31

(57) ABSTRACT

A compactable and rugged wheelbarrow stand with a first and second leg, a cross support, a first hinge coupling the first leg to the cross support, and a second hinge coupling the second leg to the cross support. The wheelbarrow stand can be compactly folded for shipping, but can be rapidly assembled with other wheelbarrow components to form a finished wheelbarrow.

### FIELD OF THE INVENTION

The present invention relates to wheelbarrow stands and, more particularly, to wheelbarrow stands that are able to collapse for storage and transportation of the wheelbarrow.

### BACKGROUND OF THE INVENTION

In the present time, many products are manufactured in foreign markets and are imported into the United States and sold. A problem inherent in this practice is the problem of shipping assembled products. It is more efficient for components of voluminous products to be shipped together in an unassembled state, with final assembly occurring at the ultimate destination of the product. This is particularly true of wheelbarrows, which have an open framework made up of handles, legs, and a wheel supporting the wheelbarrow tub. In order to reduce the shipping cost, these items are often shipped in a disassembled state. However, then the ultimate user or the retailer of the product is required to assemble the wheelbarrow, which in many vases can take 30 to 45 minutes to complete. For example, in Tonelli (U.S. Pat. No. 3,282,600) and Gates (U.S. Pat. No. 872,926) the wheelbarrows use components such as cross members to enhance the structural integrity of the wheelbarrow but these require that each element be bolted to the overall assembly.

The concept of a wheelbarrow that can be efficiently packed is discussed in Filas (U.S. Pat. No. 4,401,313), Sine (U.S. Pat. No. 3,552,760), O'Brian (U.S. Pat. No. 4,109,933), Clapp (U.S. Pat. No. 2,800,335), Leger (U.S. Pat. No. 6,017,053), Souris (U.S. Pat. No. 2,727,751), and Pharaoh (U.S. Pat. No. 5,372,376). These patents disclose wheelbarrows that are capable of becoming completely collapsed. Many of these patents, such as Clapp, disclose a wheelbarrow that collapse the wheelbarrow stand, handles and tub. This solution optimizes the ease of disassembly and assembly, and the ability to minimize space, but provides a solution that compromises the structural integrity of the tub. Pharaoh attempts to address this issue and provides a tub that folds back on to the stand and handles. Tomchak (U.S. Pat. No. 6,923,469) also attempts to address this issue by providing for a wheelbarrow that collapses the stand and handles separately from the tub. In Tomchak, the legs of the stand collapse upwardly into the handles by having sleeves joined with aft struts sliding cooperatively with the fore struts. While solutions like Pharaoh and Tomchak present clever methods for collapsing a wheelbarrow, they do not address desire for a wheelbarrow to be both efficient and strong.

The robustness of a wheelbarrow is determined by each of the components. Thus, the tub, handles, wheel, and stand all contribute to the quality of a wheelbarrow. A user desiring a rugged a wheelbarrow may be reluctant to acquire a wheelbarrow that disassembles in the manners described above because those methods promote efficiency over strength. Thus, the user may just prefer to disassemble the wheelbarrow into its component parts for purposes of storage and transportation, as disclosed in Tonelli. When a wheelbarrow is disassembled, many of the components can be efficiently stored. Wheels can be stacked upon one another, as can handles, without a giving up much space. Tubs can be stacked upon one another by placing one tub within the basin of another. Stands on the other hand present a different problem. Stands can utilize cross supports in order to promote the strength of a stand. Some cross supports couple a leg on one side to a leg on the other. However, the use of cross supports can inhibit the ability of one stand to be efficiently stacked upon another. Further, the shape of a stand can prohibit it from being efficiently stored or transported with differently shaped items.

What is needed is a wheelbarrow stand that can efficiently collapse and still integrate structurally enhancing elements. It would be beneficial if the wheelbarrow stand in a collapsed state minimized the foot print occupied by the stand. It would also be beneficial if the components of the stand were integrated in a manner to promote efficient transformation of the wheelbarrow to an assembled state.

### SUMMARY OF THE INVENTION

These and other objects are achieved by providing a wheelbarrow stand with components that are rotatably secured.

In one advantageous embodiment of the present invention, the wheelbarrow stand comprises a first leg and second leg that are coupled to a cross support by a hinge. The stand can also incorporate a second cross support that is rotatably mounted to the first leg and a securing component on the second leg for coupling the second cross support to the second leg.

The legs of the stand can comprise at least two struts which have mounts at the distal end of the struts. At least one mount can be rotatably coupled to an upper cross support such that the rotation of the cross support aligns bolt holes formed at the proximal and distal ends of the upper cross support with bolt holes formed in the mounts.

It is another aspect of this invention for the wheelbarrow stand to comprise a compacted state and an assembled state. The compacted state characterized by the legs lying across the outer face of the first cross support. The assembled state characterized by the legs forming a flush contact with the inner face of the first cross support.

It is yet another object of the present invention for the first cross support to comprise at least one interface plate which is received by a cavity formed in the first leg.

A further aspect of the present invention is for the cross support to comprise an interface section that encompasses a ledge that forms a portion of the cavity in the first leg.

These and other objects of the invention and its particular features and advantages will become more apparent from consideration of the following drawings and accompanying description.

### BRIEF DESCRIPTION OF THE DRAWINGS

FIG. 1 is a perspective view of an assembled wheelbarrow incorporating a stand in accordance with the invention.

FIG. 2 is a back perspective view of the wheelbarrow stand in FIG. 1 in a collapsed state.

FIG. 3 is a back and right perspective view of the wheelbarrow stand in FIG. 2 rotating the legs about hinges attached to a cross support.

FIG. 4 is a back and right perspective view of the wheelbarrow stand in FIG. 3 continuing the rotation of the legs about hinges attached to a cross support.

FIG. 5 is a back and right perspective view of the wheelbarrow stand in FIG. 4 with the legs and a second cross support completing rotation and the initiation of rotating the upper cross supports.

FIG. 6 is a front and left perspective view of the wheelbarrow stand in FIG. 5 in an assembled stated.

FIG. 7 is a front and left perspective view of the wheelbarrow stand in FIG. 6 aligned to be coupled to the handles, tub and tire.

FIG. 8A is a back and right perspective view of an aft cross support with strut ledge interface sections.

FIG. 8B is a back and right perspective view of the aft cross support of FIG. 8A incorporated into a wheelbarrow stand.

### DETAILED DESCRIPTION OF THE INVENTION

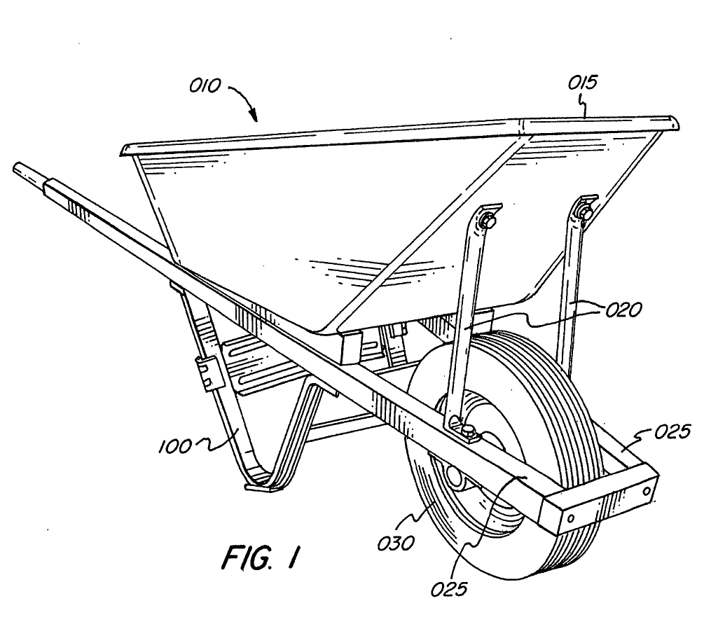

FIG. 1 shows a wheelbarrow 010 in an assembled state. The wheelbarrow 010 comprises a tub 015 mounted atop handles 025. Stays 020 couple tub 015 to the forward portion of handles 025 to provide additional support to the forward portion of tub 015. Wheel 030 is rotatably coupled to the forward portion of handles 025. These components are mounted atop wheelbarrow stand 100.

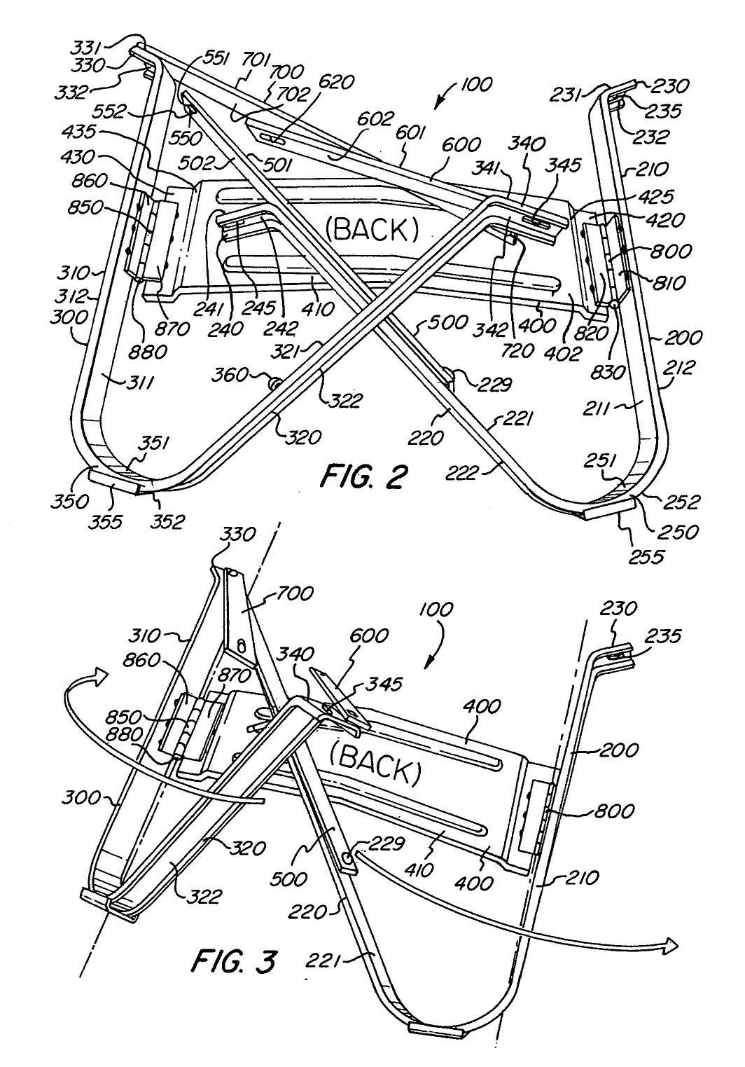

An embodiment of a collapsible wheelbarrow stand 100 is shown in a collapsed state in FIG. 2. Stand 100 incorporates a first leg 200, a second leg 300, an aft cross support 400, a fore cross support 500, a fore upper support 600, and an aft upper support 700.

The first leg 200 comprises an aft strut 210 and a fore strut 220. Aft 210 and fore 220 struts intersect to form foot 250. The aft 210 and fore 220 struts each comprise inner 211, 221 and outer 212, 222 faces. The inner face 211 of the aft strut 210 generally opposes the inner face 221 of the fore 220 strut, while the outer faces 212, 222 of both struts generally directed away from each other. FIG. 2 shows one embodiment in which the formation of foot 250 at the proximal ends of struts 210, 220. The formation of foot 250 is based on the continuous transition from the fore strut 220 to the aft 210 strut. Foot 250 has an inner face 251 that generally faces upward when the stand is assembled. FIG. 2 also shows that the stability of stand 100 can be enhanced by mounting a plate 255 to foot 250. Plate 255 opposes the outer surface of foot 250. Whereas foot 250 has a curved structure outer surface 252, plate 255 contains a face that is capable of being substantially flat and substantially parallel to the ground. Each strut 210, 220 also incorporates mounts 230 and 240 at the distal end of the struts. The preceding description of leg 200 applies equally to leg 300.

Mounts 230, 240 are used for the purpose of securing the wheel barrow handles and/or tub to the stand. Mounts 230 and 240 extend in an outward direction commensurate with the orientation of the outer faces 212, 222 of struts 210 and 220 respectively. However, these mounts could just as easily extend in an inward direction commensurate with the orientation of the inner faces 211, 221 of each strut. Mounts 230, 240 have an upward face 231 and a downward face 232. The upward faces 231, 331 of the mounts are oriented to come into contact with and oppose the downward faces 602, 702 of upper cross supports 600, 700, described in more detail below. A curved transition from a strut to a mount creates a continuous surface from an inner face of a strut to an upward face of a mount and from an outer face of a strut to a downward face of a mount. Each mount 230, 240 is also characterized by holes 235, 245 that transition from each upward face 231, 241 to each downward face 232, 242. An assembled wheelbarrow stand will align these holes with holes 620, 720 of upper cross supports 600, 700, described in more detail below, for purpose of securing the cross supports and coupling the wheelbarrow handles and/or tub to the stand 100. For instance, A mounting bolt can be placed through each hole and mechanically join with the handles and/or the tub. The preceding description of mounts 230,240 applies equally to mounts 330,340

The fore strut 220 is further characterized by a fore cross support 500 that is rotatably attached to the fore strut 220. Fore cross support 500 is used to provide structural integrity to the stand by linking the fore strut 220 of first leg 200 to the fore strut 320 of second leg 300. The cross support 500 is joined to the fore strut 220 at a proximal end of the cross support 500 and at a mid point along the strut's inner face 221. This can be achieved utilizing a rivet 229 that passes through both the cross support 500 and strut 220. The cross support 500 rotates about the axis of the rivet 229, the axis being perpendicular to the plane of the inner face 221 of the fore strut 220. As a result, the cross support 500 contains an outer face 502 that opposes the inner face 221 of the strut 220 and an inner face 501 that faces a direction common to inner face 221. As a result, the inner 501 and outer 502 faces each lie in planes that are parallel to the inner face 221 of strut 220. Put another way, support 500 rotates in a plane that is parallel to the plane of the inner face 221 to strut 220. Support 500 is further characterized by the fact that a hole 550 passes through the inner face 501 of the cross-support 500 to the outer face 502 of the cross support 500 at the distal end of the cross-support 500. This hole 550 has a first aspect 551 with a given diameter and a second aspect 552 with a different diameter. The diameter of the first aspect 551 is larger than the diameter of the second aspect 552. Further, the spaces created by these two aspects are contiguous. The function of this hole is to couple the fore strut 220 of the first leg 200 to the fore strut 320 of the second leg 300.

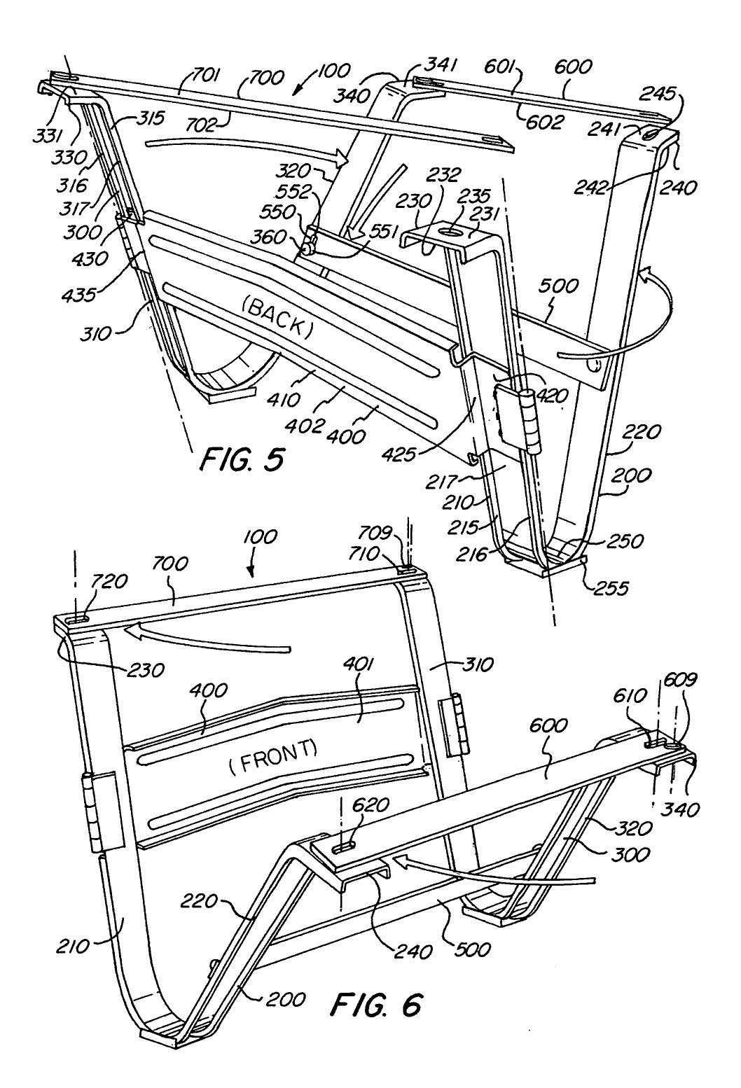

While second leg 300 has characteristics that generally reflect the characteristics of first leg 200, a first distinction is that a cross support is not mounted along the mid-point of the fore strut 320. Instead a bolt 360 is mounted to fore strut 320 and extends away from the inner face 321 of strut 320. The bolt 360 comprises an axis that is perpendicular to the plane of the inner face 321. The bolt 360 is further characterized by an expanded head and a narrow body. The expanded head has a diameter that is greater than the diameter of the narrow body. Further, the diameter of the first aspect 551 of hole 550 is greater than or equal to the diameter the head to bolt 360. The diameter of the second aspect 552 of hole 550 is greater than or equal to the diameter of the body of bolt 360. However, the diameter of the second aspect 552 of hole 550 is less than the diameter of the head to bolt 360. FIG. 5 demonstrates how cross support 500 couples fore struts 220 and 320. FIG. 5 shows that the head to bolt 360 passes through the first aspect 551 of hole 550 and the body of bolt 360 is encompassed by the first aspect 551 of hole 550. The cross support 500 is rotated in a downward direction such that the body to bolt 360 is encompassed by the second aspect 552 of hole 550. Since the diameter of the second aspect 552 is less than the diameter of the bolt head, the cross support 500 is restrained from decoupling the fore struts 220, 320.

Second leg 300 is further differentiated from first leg 200 by fore and aft upper supports 600, 700, which are rotatably coupled to mounts 340, 330 respectively. The upper supports 600, 700 are used to further enhance the stability of the overall stand 100 by further coupling the first leg 200 to the second leg 300. Further, the upper supports 600, 700 contain an upper surface 601, 701 which can come into flush contact with the handle and/or tub for purpose of mounting these elements to the stand 100. Each upper support 600, 700 is joined to a mount 340, 330 at a proximal end of each upper support 600, 700. This can be achieved utilizing rivets 609, 709 that pass through upper supports 600, 700 and mounts 340, 330. The upper supports 600, 700 rotate about the axes of each corresponding rivet 609, 709, the axes being perpendicular to the plane of each corresponding upper face 341, 331 of mounts 340, 330. As a result, each upper support 600, 700 contains a downward face 602, 702 that opposes the upward face 341, 331 of the corresponding mount 340, 330 and an upward face 601, 701 that faces a direction common to the upper face 341, 331. As a result, the upward 601, 701 and downward 602, 702 faces each lie in planes that are parallel to the corresponding upward faces 341, 331 of mounts 340, 330. Put another way, supports 600, 700 rotate in a plane that is parallel to the plane of the upward faces 341, 331 of mounts 340, 330.

Supports 600, 700 are further characterized by the presence holes at the proximal 610, 710 and distal 620, 720 ends of upper supports 600, 700. These holes pass through the upward face 601, 701 to the downward face 602, 702 of each support 600, 700. The holes 610, 710 at the proximal end are adjacent to the rivets 609, 709 that couple each support 600, 700 to each corresponding mount 340,330. FIGS. 5 and 6 illustrate the placement of the holes at the proximal 610,710 and distal 620,720 ends of upper supports 600, 700 and the relationship of the upper supports 600, 700 to the first and second legs 200, 300. The rotation of the upper supports 600, 700 about each corresponding rivet 609, 709 places the downward face 602, 702 of each support 600, 700 in flush contact with the opposing upward faces of each corresponding mount. For instance, the downward face 602 of upper support 600 is in flush contact and opposes the upper faces 241, 341 of mounts 240 and 340. The downward face 702 of upper support 700 is in flush contact and opposes the upward faces 231, 331 of mounts 230,330. The rotation of upper supports 600, 700 also aligns the upper support holes 610, 620, 710, 720 with the mount holes 235, 245, 335, 345. FIG. 5 illustrates that the upper supports 600, 700 are rotated in a clockwise direction in order to align the upper supports 600, 700 with each corresponding mount. As they are aligned, FIG. 6 shows that holes 610 and 620 are placed over holes 345 and 245 respectively. This places the space formed by each support hole 610, 620 in communication with the corresponding space formed by each mount hole 345, 245. As a result, each support hole must be sized and placed on the proximal and distal ends of the upper supports 600, 700 such that they are capable of aligning with a corresponding mount hole.

With the holes aligned, a mounting bolt can be placed through each hole and mechanically join with the handles and/or the tub. By passing bolts through these holes, the handles and/or tub are brought into contact with the upward faces 602, 702 of the upper supports 600, 700. This enables the handles and/or tub to be secured to the stand 100. The security of the handles and/or tub to the stand can be enhanced when the upward faces 602, 702 of the upper supports 600, 700 are flush with the opposing faces of the handles and/or tub. FIG. 6 also shows that the upper supports 600, 700 are characterized by the fact that their length from a proximal end to a distal end corresponds to the width of stand 100 from the first leg 200 to the second leg 300.

Another aspect of stand 100 is the use of hinges 800, 850 to mount an aft cross support 400 to aft struts 210, 310. Aft cross support 400 is used to further strengthen an assembled stand 100 and acts as the foundation for assembling and disassembling the stand 100. The aft cross support 400 contains an inner face 401 that is approximately parallel to the inner faces 211, 311 of the aft struts 210, 310 and opposes the inner face 501 of the fore cross support 500. The aft cross support 400 has an outer face 402 that is approximately parallel to the outer faces 212, 312 of aft struts 210, 310. FIG. 2 shows a pair of hinges 800, 850 that mechanically couple the aft struts 210, 310 to the aft cross support 400. Each hinge 800, 850 comprises a first plate 810, 860, a second plate 820, 870, and a pivot 830, 880. The pivot 830, 880 has an axis of rotation about which the first 810, 860 and second 820, 870 plates are rotated relative to each other. FIG. 2 shows that the first plates 810, 860 are mechanically coupled, by means such as welding, to the inner faces 211, 311 of the aft struts 210, 310. The second plates 820, 870 are mechanically coupled to the outer face 402 of aft cross support 400.

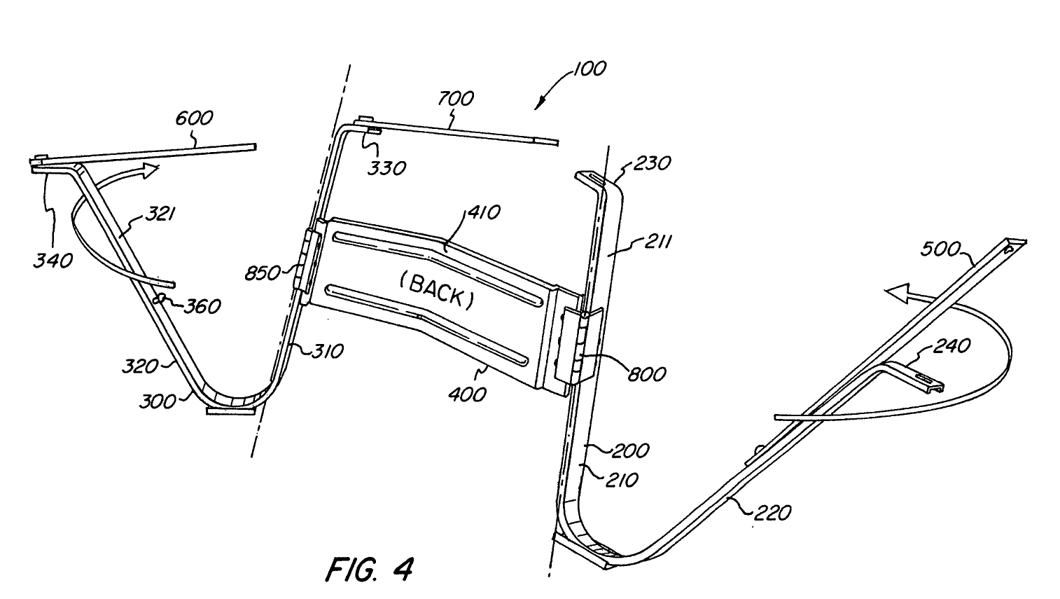

FIG. 2 shows that when stand 100 is in a compacted state the planes of the first 810, 860 and second 820, 870 plates are approximately perpendicular to one another. FIGS. 3-5 demonstrate the rotation of the plates, and correspondingly the first and second legs 200,300, about pivots 830, 880. FIGS. 3 and 4 shows that plate 860 rotates relative to plate 870 in a counterclockwise direction. Plate 810 is shown to rotate relative to plate 820 in a clockwise direction. FIG. 5 shows the completion of rotating the hinges about pivots 830, 880 approaching an assembled state. In this state, the first plates 810, 860 lie in a plane that is approximately parallel to the plane of second plates 820, 870. The resulting structure sandwiches the aft struts 210, 310 and the aft cross support 400 between the corresponding first 800, 860 and second 820, 870 plates of hinges 800 and 880. This structure places the outer faces 212, 312 of aft struts 210, 310, in flush contact with the inner face 401 of aft cross support 400. The plane of the inner face 401 of the aft cross support 400 is substantially parallel to the plane of the outer faces 212, 312 of the aft struts 210, 310.

Since stand 100 relies on the welding of hinges 800, 850 to legs 200, 300 and aft cross support 400 as means to couple the legs 200,300 to the aft cross support 400, it may be beneficial to incorporate an additional feature best displayed in FIG. 5. FIG. 5 shows that aft struts 210, 310 comprise an inner ledge 215, 315, an outer ledge 216, 316, and a strut body 217, 317. The inner 215, 315 and outer 216, 316 ledges extend away from the strut body 217, 317 of the aft struts 210, 310 creating a cavity. The aft cross support 400 is shown to have a support body 410, strut body interface plates 420, 430, and strut ledge interface sections 425, 435. The strut body interface plates 420, 430 lie in a different but substantially parallel plane to the plane of the support body 410. The sections 425, 435 lay in a plane approximately perpendicular to the planes of the plates 420, 430 and the body 410. When the stand is assembled, the length of the support body 410 spans the separation of the inner ledge 215 to inner ledge 315. Plates 420, 430 are placed within the cavities created by inner ledges 215, 315, outer ledges 216, 316, and strut bodies 217, 317. The inner faces of plates 420, 430 are brought into flush contact with the outer faces 212, 312 of strut bodies 217, 317 such that the planes of these faces are substantially parallel. The length of each plate 420, 430 in the direction that extends away from the plane of sections 425, 435 is approximately equal to the width of strut body 217, 317, spanning the separation of inner ledge 215, 315 to outer ledge 216, 316, for each aft strut 210, 310. The sections 425, 435 extend away from the outer faces 212, 312 of struts 210, 310 such that they are substantially perpendicular to the plane of strut body 217, 317. Also, the direction in which sections 425, 435 extend is substantially parallel to the direction of inner ledges 215, 315. As a result, sections 425, 435 can come into flush contact with a face of inner ledges 215, 315. By placing these plates 420, 430 within the cavities formed by the aft bodies 217, 317, the inner ledges 211, 311 and outer ledges 212, 312 ledges, the coupling strength of the of the aft cross support 400 for the aft struts 210, 310 is improved.

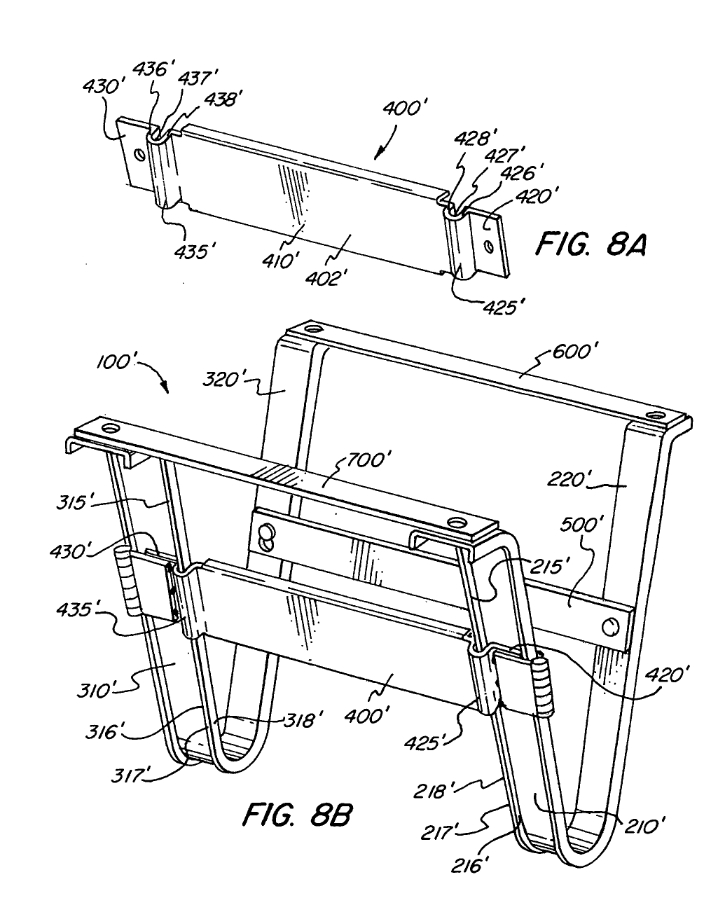

The coupling strength of the aft cross support 400 and the overall rigidity of stand 100 can be further improved by having a portion of the cross support 400 encompass the inner ledges 215, 315 of aft struts 210, 310. FIGS. 8A and 8B demonstrate an aft cross support 400′ with strut ledge interface sections 425′ and 435′ shaped to encompass inner ledges 215′ and 315′. Each section 425′, 435′ comprises an outer component 426′, 436′, a transition component 427′, 437′, and an inner component 428′, 438′. Outer component 426′, 436′ joins a strut body interface plate 420′, 430′ and the transition component 427′, 437′. Outer component 426′, 436′ extends away from the plate 420′, 430′ to transition component 427′, 437′ and lies in a plane approximately perpendicular to the planes of plate 420′, 430′ and support body 410′. Inner component 428′, 438′ joins support body 410′ and the transition component 427′, 437′. Inner component 428′, 438′ extends away from the support body 410′ to transition component 427′, 437′ and lies in a plane approximately perpendicular to the planes of plate 420′, 430′ and support body 410′. Transition component 427′, 437′ joins outer component 426′, 436′ and inner component 428′, 438′. A portion of transition component 427′, 437′ lies in a plane substantially parallel to the planes of plate 420′, 430′ and support body 410′. FIG. 8A also shows that transition component 427′, 437′ can have an arced transition between components 426′, 436′ and 428′, 438′. This will help distribute any stress placed on a section 425′, 435′ and also enable the section to serve as a spring. The shapes of sections 425′, 435′ also enable support body 410′ and plates 420′, 430′ to lie in the same plane.

FIG. 8B shows aft cross support 400′ applied to assembled stand 100′. The interface sections 425′, 435′ of aft cross support 400′ are shaped to encompass inner ledges 215′, 315′. Components 426′, 436′ and 428′, 438′ extend in a direction that is substantially parallel to the direction of inner ledges 215′, 315′. As a result, components 426′, 436′ and 428′, 438′ can each have a face that comes into flush contact with a first 216′, 316′ and third 218′, 318′ face respectively of inner ledges 215′, 315′. The first 216′, 316′ and third 218′, 318′ faces lie in a plane parallel to the direction in which inner ledge 215′, 315′ extends. Further, transition component 427′, 437′ can be shaped such that it has a face that comes into flush contact with a second face 217′, 317′of inner ledge 215′, 315′. The third face lies in a plane perpendicular to the direction in which inner ledge 215′, 315′ extends. By having sections 425′, 435′ encompass ledges 215′, 315′, the lateral cross support of stand 100′ is improved. This structure is also able to further reduce the side to side racking of the stand components between each other.

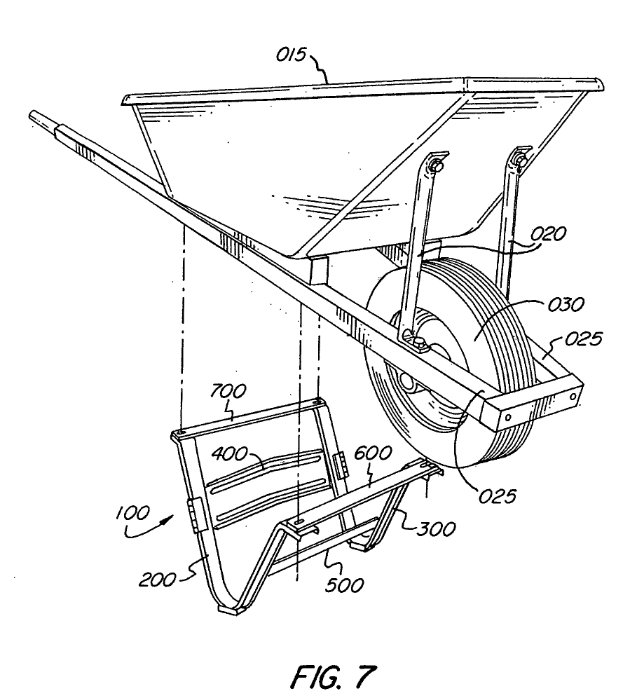

A description of the method of assembling the wheel barrow stand herein described from a compact state to an assembled state will be made with reference to FIGS. 2-6. FIG. 2 displays the wheel barrow stand in a compact state. The first 200 and second 300 legs are folded relative to the aft cross support 400 such that fore strut 220 of the first leg 200 lays on top of the aft cross support 400 and the fore strut 320 of the second leg 300 lays on top of the fore strut 220 of the first leg 200. The fore cross support 500 and the upper cross supports 600,700 are in a rotated position such that they lay substantially in the area spanning from the aft strut 210 of the first leg 200 to the aft strut 310 of the second leg 300 and the mounts 230, 330 to the aft struts 210, 310 and the feet 250, 350 of the first 200 and second 300 legs. The first step in assembling the stand 100 is to rotate the first 200 and second 300 legs out of the compact position and away from the aft cross support 400. Each leg will rotate from a position associated with the outer face 402 of the aft cross support 400 to a position associated with the inner face 401 of the aft cross support 400. The outer faces 212, 312 of the aft struts 210,310 will rotate approximately 270 degrees about the axis of each corresponding hinge 800, 850. Once the outer faces 212, 312 of the aft struts 210, 310 comes into flush contact with the inner face 401 of the aft cross support 400, the fore cross support 500 and the upper cross supports 600, 700 are moved into position. The fore cross support 500 is rotated in a clockwise direction until the hole 550 on the distal end of the cross support 500 is aligned with the bolt 360 mounted on the inner face 321 of the fore strut 320 of the second leg 300. The head of bolt 360 is slid through the first aspect 551 of the cross support hole 550 until the body of the bolt 360 is encompassed by the first aspect 551. The fore cross support 500 is further rotated in a clockwise direction such that the body of the bolt 360 is secured within the second aspect 552 of the cross support hole 550. Subsequently, the fore 600 and aft 700 upper cross supports are rotated in a clockwise direction until the holes 610, 620, 710, 720 in the proximal and distal ends are aligned with the holes 345, 245, 335, 235 formed in the mounts 340, 240, 330, 230 of the first 200 and second 300 legs. At this stage all of the components of the stand 100 are properly aligned. FIG. 7 shows the final step of coupling the stand 100 to the remaining components of the wheelbarrow. Here the wheel barrow handles, with tub mounted above, are aligned over the stand 100. The surface on the underside of the handle is brought into contact with the upper surfaces 601, 701 of the upper cross supports 600, 700. Once properly aligned, bolts can be passed through the mount holes 230, 240, 330, 40 and upper support holes 720, 620, 710, 610 and into the handle. These bolts secure the handle and/or tub to the stand 100. The bolts also help maintain the orientation of the upper supports 600, 700 over the mounts 240, 340, 230, 330 and further assist the coupling of the legs 200, 300.

In the preferred embodiment, stand 100 is fabricated from steel. However, the stand 100 could also benefit from the use of light weight or durable materials, including other metal alloys, composites, or hard plastics.

The present invention provides a wheelbarrow stand and wheelbarrow which can be compactly folded for shipping, but which can be rapidly assembled to a finished wheelbarrow in seven (7) minutes or less.

Although the invention has been described with reference to a particular arrangement of parts, features, and the like, these are not intended to exhaust all possible arrangements or features, and indeed many modifications and variations will be ascertainable to those of skill in the art.

What is claimed is:

1. A compactable and rugged wheelbarrow stand, comprising:
a first leg
a second leg
at least one cross support;
a first hinge coupling the first leg to the cross support; and
a second hinge coupling the second leg to the cross support.

2. The wheelbarrow stand in claim 1 wherein the first and the second legs each comprise at least two struts.

3. The wheelbarrow stand in claim 2 further comprising a first cross support coupled to the first and second legs by the first and second hinges and a second cross support rotatably mounted to the first leg at the proximal end of the second cross support.

4. The wheelbarrow stand in claim 3 wherein the second cross support includes a first securing component that is capable of coupling with a second securing component on the second leg.

5. The wheelbarrow stand in claim 4 wherein the struts of the first leg meet at the proximal end of each strut to form a first foot and the struts of the second leg meet at the proximal end of each strut to form a second foot.

6. The wheelbarrow stand in claim 5 wherein a mount is located at the distal end of each strut.

7. The wheelbarrow stand in claim 6 further comprising at least one upper cross support rotatably coupled to at least one mount at the proximal end of the upper cross support.

8. The wheelbarrow stand in claim 7, wherein each mount comprises a bolt hole, wherein the upper cross support comprises a bolt hole at the proximal and distal ends of the upper cross support, wherein rotating the upper cross support aligns the bolt hole formed in the proximal end of the upper cross support with a bolt hole formed in a first mount and aligns the bolt hole formed in the distal end of the upper cross support with the bolt hole formed in a second mount.

9. The wheelbarrow stand in claim 7, wherein the stand is foldable to a compacted state in which the first leg lays across the second leg and wherein the first and second legs lay across an outer face of the first cross support.

10. The wheelbarrow stand in claim 9, wherein the compacted state further comprises the first cross support, the second cross support, and the upper cross support substantially laying in an area formed by the first leg laying across the second leg.

11. The wheelbarrow stand in claim 9, wherein the stand is openable to an assembled state in which a face of the first leg and a face of the second leg are flush with an inner face of the first cross support.

12. The wheelbarrow stand in claim 1, wherein the first leg includes a cavity for receiving a portion of the cross support.

13. The wheelbarrow stand in claim 12, wherein the cross support comprises an interface plate sized to be received in the cavity.

14. The wheelbarrow stand in claim 13, wherein a first dimension of the interface plate is approximately equal to a first dimension of the cavity.

15. The wheelbarrow stand in claim 14, wherein the first hinge is coupled to the interface plate of the cross support.

16. A method for assembling a compactable and rugged wheelbarrow stand, comprising:
rotating a first leg coupled to a cross support by a first hinge;
rotating a second leg coupled to the cross support by a second hinge;
mating an outer face of the first leg with an inner face of the cross support; and
mating an outer face of the second leg with the inner face of the cross support.

17. The method of claim 16 further comprising rotating a second cross support rotatably mounted to the first leg and coupling the second cross support to the second leg.

18. The method of claim 17 further comprising rotating an upper cross support coupled to a mount formed at a distal end of the first leg and aligning a hole formed in the distal end of the upper cross support with a hole formed in a mount at a distal end of the second leg.

19. The method of claim 16 wherein rotating the first leg begins from an initial compacted state in which the first leg lays across the second leg or the second leg lays across the first leg, and the first and second legs lay across an outer face of the cross support.

20. The method of claim 16 wherein mating the first leg with the cross support further comprises a cavity in the first leg receiving an interface plate formed in the cross support.

21. A rugged wheelbarrow stand, comprising:
a first leg
a second leg; and
a cross support that couples the first leg to the second leg;
wherein the cross support comprises an interface section that encompasses a component of the first leg.

22. The wheelbarrow stand in claim 21, wherein the first leg comprises a ledge and the interface section encompasses the ledge.

23. The wheelbarrow stand in claim 22, wherein the ledge forms a portion of a cavity for receiving a portion of the cross support.

24. The wheelbarrow stand in claim 22, wherein the cross support further comprises an interface plate sized to be received in the cavity.

25. The wheelbarrow stand in claim 23, wherein the cross support further a cross support body coupled to the interface plate.

26. The wheelbarrow stand in claim 24, wherein the interface section couples the cross support body to the interface plate.

27. The wheelbarrow stand in claim 25, wherein the interface section comprises a transition component that couples an outer component and an inner component of the interface section.

28. The wheelbarrow stand in claim 26, wherein a first dimension of the interface plate is approximately equal to a first dimension of the cavity.
